(19) United States
(12) Patent Application Publication
(10) Pub. No.: US 2025/0256774 A1
(43) Pub. Date: Aug. 14, 2025

(54) VEHICLE STEER-BY-WIRE SYSTEM AND CONTROL METHOD THEREOF

(71) Applicant: HYUNDAI MOBIS CO., LTD., Seoul (KR)

(72) Inventors: Jeong Min LEE, Yongin-si (KR); Hyun Su KIM, Yongin-si (KR); Hee Kyu LIM, Yongin-si (KR); Hyung Ju KWON, Yongin-si (KR)

(73) Assignee: HYUNDAI MOBIS CO., LTD., Seoul (KR)

(21) Appl. No.: 18/670,833

(22) Filed: May 22, 2024

(30) Foreign Application Priority Data
Feb. 8, 2024 (KR) 10-2024-0019583

(51) Int. Cl. B62D 15/02; B62D 5/04

(52) U.S. Cl. CPC B62D 15/022; B62D 5/0481

(57) ABSTRACT

An electronic steering system for a vehicle includes an input module configured to receive a steering command angle from a cooperative control unit, a steering angle sensor configured to detect a steering angle of a steering wheel of the vehicle, a memory, and a processor operatively coupled to the input module, the steering angle sensor, and the memory. The processor is configured to, when a cooperative control command angle is input from the input module, calculate a steering angle offset and a command angle offset, and then perform steering angle position control with respect to the cooperative control command angle by sequentially ramping down the steering angle offset and the command angle offset to output a pinion angle of a wheel of the vehicle.

### CROSS-REFERENCE TO RELATED APPLICATIONS

This application claims priority from and the benefit of Korean Patent Application No. 10-2024-0019583, filed on Feb. 8, 2024, which is hereby incorporated by reference for all purposes as set forth herein.

### TECHNICAL FIELD

Exemplary embodiments of the present disclosure relate to a vehicle steer-by-wire system and a control method thereof.

### BACKGROUND

In general, in vehicle steering apparatuses, power steering systems have been developed and applied to provide convenience in driving operations by assisting the driver's steering wheel maneuverability, wherein such power steering systems have been developed and applied as hydraulic systems using hydraulic pressure, electro-hydraulic systems using both hydraulic pressure and electric power of a motor, and electric systems using only electric power of a motor.

In recent years, an electronic steering system has been developed and applied in the form of Steer-By-Wire (SBW), which eliminates a mechanical connection such as a steering column, a universal joint, and a pinion shaft between a steering wheel and vehicle road wheels, and controls the driving of a motor connected to a rack bar with electrical signals to steer a vehicle.

Such an electronic steering system may include a steering wheel for driver's steering operation, a reaction force motor installed on one side of the steering wheel to provide reaction force torque according to the rotation of the steering wheel, a steering motor connected to a rack bar to implement a steering operation, sensors for detecting a steering angle, vehicle speed, and torque of the steering wheel, and an Electronic Control Unit (ECU) for driving the steering motor and the reaction force motor according to electrical signals input from the sensors.

Such an SBW-type electronic steering system has the advantages of reducing driver injuries caused by mechanical parts in the event of a vehicle collision due to the absence of mechanical connections, reducing the weight of a vehicle and unnecessary energy consumption during the steering operation due to the reduction of mechanical connection parts, and achieving ideal steering performance by ECU programming, and is being increasingly used.

As such, the SBW-type electronic steering system has the advantage of eliminating the mechanical connection structure of the conventional steering system, thereby increasing the layout freedom of steering system configurations, improving fuel efficiency, and eliminating disturbances that are back-input from the vehicle road wheels.

On the other hand, if an emergency situation arises during autonomous driving, such as a sudden risk of a collision or other accident, a vehicle needs to perform speed or steering control to avoid the emergency. To avoid such an emergency, slowing down is effective, but, if necessary, driver's steering may be required. For example, if the autonomous driving system fails, a vehicle may be driven away from the driver's intentions, so the driver's steering needs to be essentially considered.

In other words, in SBW systems, the steering angle of the steering wheel and the pinion angle of the wheel are affected by the software variable gear ratio (VGR) by vehicle speed and mode, so the position control command of the pinion angle is not always consistent and changes frequently depending on the vehicle speed and steering angle.

Therefore, in the case of an SBW system for autonomous driving, the pinion angle follows the steering angle, and the steering angle needs to be positioned with the cooperative control command angle of an advanced driver assistance system (ADAS) to enable quick driver switching.

However, when calculating the autonomous driving command with the pinion angle, a difference occurs with the steering angle, resulting in a position difference between the steering angle and the pinion angle, making it difficult to perform accurate cooperative control when performing the cooperative control command angle of ADAS.

The Background of the present disclosure is disclosed in Unexamined Korean Patent Publication No. 10-2022-0064012 (published on May 18, 2022 and entitled “Steer-By-Wire System Steering Control Apparatus and Method”)

The above-described information disclosed in the Background of the present disclosure is intended only to provide a better understanding of the Background of the present disclosure and may therefore include information that does not constitute the related art.

### SUMMARY

Various embodiments are directed to a steer-by-wire (SBW) type electronic steering system for a vehicle and a control method thereof, in which an offset from a steering angle and an offset from a variable gear ratio (VGR) command angle with respect to a cooperative control command angle are calculated and then a ramp-down gain is adjusted to match the cooperative control command angle with a steering position control angle and a pinion angle to switch to a steering position control mode.

The problem to be solved by the present disclosure is not limited to the problem mentioned above, and other problems not mentioned will be clearly understood by those skilled in the art from the following description.

In an embodiment, an electronic steering system for a vehicle, including: an input module configured to receive a steering command angle from a cooperative control unit; a steering angle sensor configured to detect a steering angle; a memory; and a processor operatively coupled to the input module, the steering angle sensor, and the memory, wherein the processor is configured to, when a cooperative control command angle is input from the input module, calculate a steering angle offset and a command angle offset, and then perform steering angle position control with respect to the cooperative control command angle by sequentially ramping down the steering angle offset and the command angle offset to output a pinion angle.

The processor may be configured to sequentially ramp down and apply the steering angle offset during the feedback of an output value for steering angle position control.

The processor may be configured to sequentially ramp down the steering angle offset and the command angle offset and apply the ramped-down offsets to an output value of the steering angle position control to output the pinion angle.

The steering angle offset may be a difference between the cooperative control command angle and the steering angle, and the command angle offset may be a difference between the VGR command angle and the cooperative control command angle.

The processor may be configured to, upon input of the steering angle, output a pinion angle through tuning of VGR.

In an embodiment, a method of controlling, with a processor, an electronic steering system for a vehicle, including: determining whether a cooperative control command angle is input from an input module; calculating a steering angle offset and a command angle offset if the cooperative control command angle is input; and outputting a pinion angle by performing steering angle position control with respect to the cooperative control command angle while sequentially ramping down the steering angle offset and the command angle offset.

The outputting of the pinion angle may include sequentially ramping down and applying the steering angle offset during the feedback of an output value for steering angle position control.

The outputting of the pinion angle may include sequentially ramping down the steering angle offset and the command angle offset and applying the ramped-down offsets to an output value of the steering angle position control to output the pinion angle.

The steering angle offset may be a difference between the cooperative control command angle and the steering angle, and the command angle offset may be a difference between the VGR command angle and the cooperative control command angle.

The method may further include, upon input of the steering angle, outputting a pinion angle through tuning of VGR.

According to embodiments of the present disclosure, in the steer-by-wire (SBW) type electronic steering system for a vehicle and the control method thereof, an autonomous driving command may be performed by calculating the steering angle offset and the pinion angle offset with respect to the cooperative control command angle and then adjusting the ramp-down gain to match the cooperative control command angle with the position control angle and the pinion angle, and switching to the steering angle position control mode.

However, the effects that may be obtained by the present disclosure are not limited to the effects described above, and other technical effects not mentioned will be clearly understood by those skilled in the art from the following description of the present disclosure.

### BRIEF DESCRIPTION OF THE DRAWINGS

FIG. 1 is a block diagram illustrating an electronic steering system for a vehicle according to an embodiment of the present disclosure;

FIG. 2 is a logic diagram for performing steering angle position control in the electronic steering system for a vehicle according to an embodiment of the present disclosure; and

FIG. 3 is a flowchart illustrating a method of controlling an electronic steering system for a vehicle according to an embodiment of the present disclosure.

### DETAILED DESCRIPTION

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

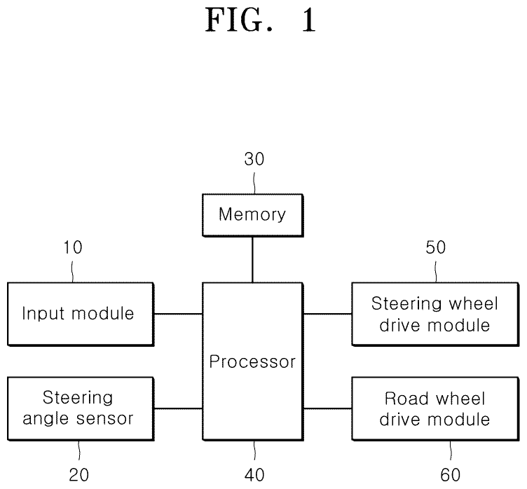

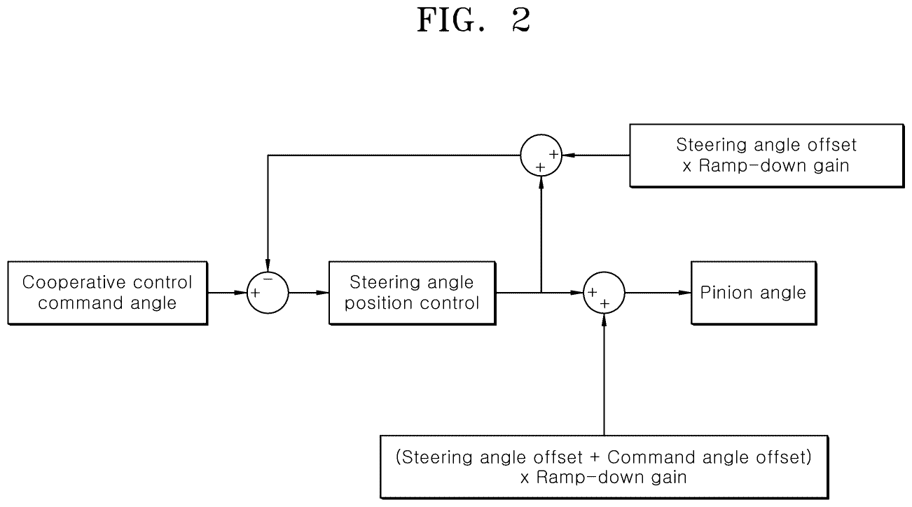

FIG. 1 is a block diagram illustrating an electronic steering system for a vehicle according to an embodiment of the present disclosure, and FIG. 2 is a logic diagram for performing steering angle position control in the electronic steering system for a vehicle according to an embodiment of the present disclosure.

As illustrated in FIG. 1, the electronic steering system for a vehicle according to the embodiment of the present disclosure may include a steering wheel drive module 50 and a road wheel drive module 60, as well as an input module 10, a steering angle sensor 20, a memory 30, and a processor 40.

The input module 10 may receive a cooperative control command angle from a cooperative control unit via in-vehicle Control Area Network (CAN) communication.

Here, the input module 10 may receive not only the cooperative control command angle from the cooperative control unit such as an ADAS, but also the operating status of the steering wheel drive module 50 and the road wheel drive module 60, as well as the vehicle speed and drive mode from an in-vehicle electronic control unit.

The steering angle sensor 20 may detect a steering angle of the steering wheel.

The steering wheel drive module 50 may generate reaction torque according to the rotation of the steering wheel to provide a steering feeling, and may also drive the steering wheel when cooperative control by autonomous driving is performed.

The road wheel drive module 60 may drive and steer road wheels according to a pinion angle that is a command angle.

The memory 30 may store data concerned to an executable program for the operation of the electronic steering system, and the information stored may be independently selected by the processor 40 as needed.

In other words, the memory 30 stores various types of data generated in the process of executing an operating system or application (program or applet) for the operation of the electronic steering system. In this context, the memory 30 refers to a non-volatile storage that retains stored information even when power is not supplied, and a volatile storage that requires power to retain stored information. Further, the memory 30 may perform a function of temporarily or permanently storing data processed by processor 40.

Here, the memory 30 may include magnetic storage media or flash storage media in addition to volatile storages that require power to retain stored information, but the scope of the present disclosure is not limited thereto.

The processor 40 is operatively coupled to the input module 10, the steering angle sensor 20, the steering wheel drive module 50, the road wheel drive module 60, and the memory 30 to copy and execute various programs stored in the memory 30 for controlling the overall operation of the electronic steering system to perform various operations.

While the processor 40 is described herein as including only one CPU, it may be implemented to control the steering wheel drive module 50 and the road wheel drive module 60, respectively, via a plurality of CPUs (or DSPs, SoCs, etc.).

In various embodiments, the processor 40 may be implemented as a digital signal processor (DSP), a microprocessor, or a time controller (TCON) that processes digital signals. However, the processor is not limited thereto, but the processor 40 may include, or be defined as, one or more of a central processing unit (CPU), a microcontroller unit (MCU), a micro processing unit (MPU), a controller, an application processor (AP) or a communication processor (CP), or an ARM processor. The processor 40 may also be implemented as a processing algorithm-embedded system on chip (SoC), large scale integration (LSI), or a field programmable gate array (FPGA).

In other words, the processor 40 may be configured to output a steering angle offset and a command angle offset when a cooperative control command angle is input from the input module, and then perform steering angle position control for the cooperative control command angle while sequentially ramping down the steering angle offset and the command angle offset to output a pinion angle.

Here, the steering angle offset may be calculated as a difference between the cooperative control command angle and the steering angle, and the command angle offset may be calculated as a difference between the VGR command angle and the cooperative control command angle.

A description will be made in more detail with reference to FIG. 2.

The processor 40 may sequentially ramp down and apply the steering angle offset during the feedback of an output value for steering angle position control with respect to the cooperative control command angle.

That is, by sequentially applying a ramp-down gain from 1 to 0, the steering angle offset may be eliminated so that the cooperative control command angle and the steering angle are matched to each other.

Further, the processor 40 may sequentially ramp down the steering angle offset and the command angle offset and apply the ramped-down offsets to the output value of the steering angle position control to output the pinion angle.

In other words, by sequentially applying a ramp-down gain from 1 to 0, the steering angle offset and the command angle offset may be controlled so that the cooperative control command angle and the pinion angle are matched to each other.

In this way, the steering angle offset and the command angle offset are sequentially eliminated to switch to the steering angle position control mode, so that the pinion angle may be controlled by the steering angle position control without deviation of the positions of the steering angle and the pinion angle to perform an autonomous driving command.

On the other hand, the processor 40 may output the pinion angle through VGR tuning according to the vehicle speed and drive mode when the steering angle is input from the steering angle sensor 20 by the driver's steering action.

As described above, in the steer-by-wire type electronic steering system for a vehicle according to an embodiment of the present disclosure, the steering angle offset and the pinion angle offset with respect to the cooperative control command angle may be calculated and then the ramp-down gain is adjusted so that the cooperative control command angle and the position control angle are matched to switch to the steering angle position control mode to perform an autonomous driving command.

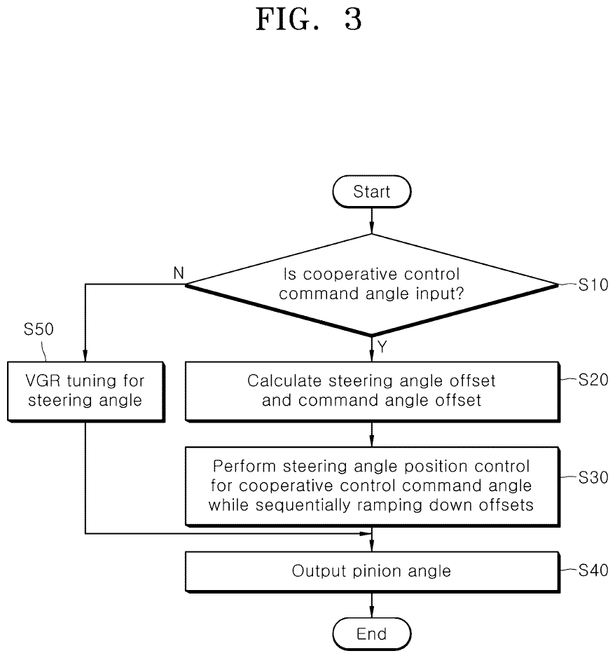

FIG. 3 is a flowchart illustrating a method of controlling an electronic steering system for a vehicle according to an embodiment of the present disclosure.

As illustrated in FIG. 3, in the method of controlling the electronic steering system for a vehicle according to the embodiment of the present disclosure, the processor 40 first executes and drives an executable program embedded in the memory 30 and determines whether a cooperative control command angle is input from the cooperative control device through the input module 10 (S10).

As a result of the determination in S10, if the cooperative control command angle is input from the cooperative control device such as an ADAS for autonomous driving, the processor 40 calculates the steering angle offset and the command angle offset of a vehicle (S20).

Here, the steering angle offset may be calculated as a difference between the cooperative control command angle and the steering angle, and the command angle offset may be calculated as a difference between the VGR command angle and the cooperative control command angle.

After calculating the steering angle offset and the command angle offset in S20, the processor performs steering angle position control with respect to the cooperative control command angle by sequentially ramping down the steering angle offset and the command angle offset (S30).

As illustrated in FIG. 2, the processor 40 may sequentially ramp down and apply the steering angle offset during the feedback of an output value for steering angle position control with respect to the cooperative control command angle.

That is, by sequentially applying a ramp-down gain from 1 to 0, the steering angle offset may be eliminated so that the cooperative control command angle and the steering angle are matched to each other.

Further, the processor 40 may sequentially ramp down the steering angle offset and the command angle offset and apply the ramped-down offsets to the output value of the steering angle position control to output the pinion angle.

In other words, by sequentially applying a ramp-down gain from 1 to 0, the steering angle offset and the command angle offset may be controlled so that the cooperative control command angle and the pinion angle are matched to each other.

In this way, the processor 40 may control the steering wheel drive module by sequentially eliminating the steering angle offset and the command angle offset to switch to the steering angle position control mode to perform steering angle position control for the cooperative control command angle, and control the steering wheel drive module 50 by outputting the pinion angle that is the result of the steering angle position control (S40).

On the other hand, as a result of the determination in S10, if the steering angle obtained by the driver's steering action is input from the steering angle sensor 20 without the input of the cooperative control command angle, the processor 40 performs VGR tuning according to the vehicle speed and the drive mode (S50).

After performing the VGR tuning in step S50, the processor 40 outputs the pinion angle based on the VGR tuning (S60).

As described above, according to embodiments of the present disclosure, in the steer-by-wire (SBW) type electronic steering system for a vehicle and the control method thereof, an autonomous driving command may be performed by calculating the steering angle offset and the pinion angle offset with respect to the cooperative control command angle and then adjusting the ramp-down gain to match the cooperative control command angle with the position control angle and the pinion angle, and switching to the steering angle position control mode.

What is claimed is:

1. An electronic steering system for a vehicle, the system comprising:
an input module configured to receive a steering command angle from a cooperative control unit of the electronic steering system;
a steering angle sensor configured to detect a steering angle of a steering wheel of the vehicle;
a memory; and
a processor operatively coupled to the input module, the steering angle sensor, and the memory, wherein the processor is configured to, when a cooperative control command angle is input from the input module, calculate a steering angle offset and a command angle offset, and then perform steering angle position control with respect to the cooperative control command angle by sequentially ramping down the steering angle offset and the command angle offset to output a pinion angle of a wheel of the vehicle.

2. The electronic steering system of claim 1, wherein the processor is configured to sequentially ramp down and apply the steering angle offset during the feedback of an output value for the steering angle position control.

3. The electronic steering system of claim 1, wherein the processor is configured to sequentially ramp down the steering angle offset and the command angle offset and apply ramped-down offsets obtained by sequentially ramping down the steering angle offset to an output value of the steering angle position control to output the pinion angle.

4. The electronic steering system of claim 1, wherein the steering angle offset is a difference between the cooperative control command angle and the steering angle, and the command angle offset is a difference between a variable gear ratio (VGR) command angle and the cooperative control command angle.

5. The electronic steering system of claim 1, wherein the processor is configured to, upon input of the steering angle, output the pinion angle through tuning of a variable gear ratio (VGR).

6. The electronic steering system of claim 1, wherein the sequentially ramping down of the steering angle offset is performed by sequentially applying a ramp-down gain from 1 to 0.

7. A method of controlling, with a processor, an electronic steering system for a vehicle, the method comprising:
determining whether a cooperative control command angle is input from an input module of the electronic steering system;
calculating a steering angle offset of a steering wheel of the vehicle and a command angle offset if the cooperative control command angle is input; and
outputting a pinion angle of a wheel of the vehicle by performing steering angle position control with respect to the cooperative control command angle while sequentially ramping down the steering angle offset and the command angle offset.

8. The method of claim 7, wherein the outputting of the pinion angle comprises sequentially ramping down and applying the steering angle offset during the feedback of an output value for the steering angle position control.

9. The method of claim 7, wherein the outputting of the pinion angle comprises sequentially ramping down the steering angle offset and the command angle offset and applying the ramped-down offsets obtained by sequentially ramping down the steering angle offset to an output value of the steering angle position control to output the pinion angle.

10. The method of claim 7, wherein the steering angle offset is a difference between the cooperative control command angle and the steering angle, and the command angle offset is a difference between a variable gear ratio (VGR) command angle and the cooperative control command angle.

11. The method of claim 7, further comprising, upon input of the steering angle, outputting a pinion angle through tuning of a variable gear ratio (VGR).

12. The electronic steering system of claim 7, wherein the sequentially ramping down of the steering angle offset is performed by sequentially applying a ramp-down gain from 1 to 0.
